(19) United States
(12) Patent Application Publication
(10) Pub. No.: US 2022/0371110 A1
(43) Pub. Date: Nov. 24, 2022

(54) CUTTING TOOL

(71) Applicant: Sumitomo Electric Hardmetal Corp., Itami-shi, Hyogo (JP)

(72) Inventor: Hidekazu KOJO, Itami-shi, Hyogo (JP)

(73) Assignee: Sumitomo Electric Hardmetal Corp., Itami-shi, Hyogo (JP)

(21) Appl. No.: 17/636,033

(22) PCT Filed: Jul. 6, 2021
(86) PCT No.: PCT/JP2021/025434

§ 371 Date: Feb. 17, 2022

(30) Foreign Application Priority Data
Oct. 29, 2020 (JP) 2020-181229

(51) Int. Cl. B23C 5/24; B23B 51/08

(52) U.S. Cl. CPC B23C 5/24; B23B 51/08

(57) ABSTRACT

A cutting tool includes a body, a blade, and a position adjustment screw. The body surrounds an axial line. The blade includes a cutting edge portion and a shank portion. The position adjustment screw is in contact with the shank portion. The position adjustment screw includes a head portion in contact with the shank portion and a joint portion continuous to the head portion and joined to the body. The head portion includes a tip end surface in contact with the shank portion, a connection surface continuous to the joint portion, and an outer circumferential surface continuous to each of the tip end surface and the connection surface. When viewed in a direction perpendicular to the axial line, a part of the outer circumferential surface is exposed through the second hole and a remainder of the outer circumferential surface is covered with the body.

### TECHNICAL FIELD

The present disclosure relates to a cutting too). The present application claims priority to Japanese Patent Application No. 2020-181220 filed on Oct. 29,2020, the entire contents of which are herein incorporated by reference.

### BACKGROUND ART

Japanese Patent Laying-Open No. 2016-068254 (PTL 1) describes a chip removing machining tool including a cutting insert cartridge and a tool body. The cutting insert cartridge is arranged in a groove provided in an outer circumferential surface of the tool body.

### CITATION LIST

### Patent Literature

PTL 1: Japanese Patent. Laying-Open No. 2016-068254

### SUMMARY OF INVENTION

A cutting tool according to the present disclosure is a cutting tool that rotates around an axial line, and includes a body , a blade, and a position adjustment screw. The body surrounds the axial line. The blade includes a cutting edge portion and a shank portion that holds the cutting edge portion. The position adjustment screw is in contact, with the shank portion. The body is provided with a first hole in which each of the shank portion and the position adjustment screw is arranged and a second hole, the first hole extending along a direction in parallel to the axial line, the second hole being continuous to the first hole and extending along a direction intersecting with the axial line. The position adjustment screw includes a head portion in contact with the shank portion and a joint portion continuous to the head portion and joined to the body. The head portion includes a tip end surface in contact with the shank portion, a connection surface continuous to the joint portion , and an outer circumferential surface continuous to each of the tip end surface and the connection surface. When viewed in a direction perpendicular to the axial line, a part of the outer circumferential surface is exposed through the second hole and a remainder of the outer circumferential surface is covered with the body.

A cutting tool according to the present disclosure is a cutting tool that rotates around an axial line, and includes a body, a blade, and a position adjustment screw. The body surrounds the axial line. The blade includes a cutting edge portion and a shank portion that holds the cutting edge portion. The position adjustment screw is in contact with the shank portion. The body is provided with a first hole in which each of the shank portion and the position adjustment screw is arranged and a second hole, the first hole extending along a direction in parallel to the axial line, the second hole being continuous to the first hole and extending along a direction intersecting with the axial line. The position adjustment screw includes a head portion in contact with the shank portion and a joint portion continuous to the head portion and joined to the body. The head portion includes a tip end surface in contact with the shank portion, a connection surface continuous to the joint portion, and an outer circumferential surface continuous to each of the tip end surface and the connection surface. When viewed in a direction perpendicular to the axial line, a part of the outer circumferential surface is exposed through the second hole and a remainder of the outer circumferential surface is covered with the body. The outer circumferential surface is provided with slits extending along the direction in parallel to the axial line. When viewed in the direction perpendicular to the axial line, a part of the slits is exposed through the second hole and a remainder of the slits is covered with the body. In the direction in parallel to the axial line, a length of each of the slits is longer than a width of the second hole. The length of each of the slits in the direction in parallel to the axial line is at least two times as long as a diameter of the head portion In a cross-section perpendicular to the axial line, a circumferential angle between two adjacent slits of the slits is at least one time and at most two times as large as a circumferential angle of the second hole in an outer circumferential end surface of the body When viewed in the direction perpendicular to the axial line, at least two slits of the slits are exposed through the second hole. The tip end surface is provided with a groove.

### BRIEF DESCRIPTION OF DRAWINGS

FIG. 1 is a schematic perspective view showing a construction of a cutting tool according to the present embodiment.

FIG. 2 is a schematic plan view showing the construction of the cutting tool according to the present embodiment.

FIG. 3 is a schematic cross-sectional view along the line III-III in FIG. 2.

FIG. 4 is a schematic perspective view showing a construction of a position adjustment screw of the cutting tool according to the present embodiment.

FIG. 5 is a schematic plan view showing the construction of the position adjustment screw of the cutting tool according to the present embodiment

FIG. 6 is a schematic front view showing the construction of the position adjustment screw of the cutting tool according to the present embodiment.

FIG. 7 is a schematic side view showing the construction of the cutting tool according to the present embodiment.

FIG. 8 is a schematic cross-sectional view along the line VIII-VIII in FIG. 2.

FIG. 9 is a schematic cross-sectional view along the line IX-IX in FIG. 2.

FIG. 10 is a schematic perspective view showing a construction of a first modification of the position adjustment screw of the cutting tool according to the present embodiment.

FIG. 11 is a schematic plan view showing the construction, of the first modification of the position adjustment screw of the cutting tool according to the present embodiment.

FIG. 12 is a schematic front view showing the construction of the first modification of the position adjustment screw of the cutting tool according to the present embodiment.

FIG. 13 is a schematic perspective view showing a construction of a second modification of the position adjustment screw of the cutting tool according to the present, embodiment.

FIG. 14 is a schematic plan view showing the construction of the second modification of the position adjustment screw of the cutting tool according to the present embodiment.

FIG. 15 is a schematic front view showing the construction of the second modification of the position adjustment screw of the cutting tool according to the present embodiment.

FIG. 16 is a schematic perspective view showing a construction of a third modification of the position adjustment screw of the cutting tool according to the present embodiment.

FIG. 17 is a schematic plan view showing the construction of the third modification of the position adjustment screw of the cutting tool according to the present embodiment.

FIG. 18 is a schematic front view showing the construction of the third modification of the position adjustment screw of the cutting tool according to the present, embodiment.

FIG. 19 is a schematic cross-sectional view along the line XIX-XIX in FIG. 17.

FIG. 20 is a schematic cross-sectional view showing a method of adjusting a position of a blade by using the position adjustment screw.

### DETAILED DESCRIPTION

### Problem to be Solved by the Present Disclosure

An object of the present disclosure is to provide a cutting tool high in rigidity.

### Advantageous Effect of the Present Disclosure

According to the present disclosure, a cutting tool high in rigidity can be provided.

Description of Embodiments of the Present Disclosure

Embodiments of the present disclosure will initially be listed and described.

(1) A cutting tool 100 according to the present disclosure is cutting tool 100 that rotates around an axial line A, and includes a body 10, a blade 20, and a position adjustment screw 30. Body 10 surrounds axial line A. Blade 20 includes a cutting edge portion 21 and a shank portion 22 that holds cutting edge portion 21 Position adjustment screw 30 is in contact with shank portion 22. Body 10 is provided with a first hole 41 in which each of shank portion 22 and position adjustment screw 30 is arranged and a second hole 42, first hole 41 extending along a direction in parallel to axial line A, second hole 42 being continuous to first hole 41 and extending along a direction intersecting with axial line A. Position adjustment screw 30 includes a head portion 31 in contact with shank portion 22 and a joint portion 32 continuous to head portion 31 and joined to body 10. Head portion 31 includes a tip end surface 33 in contact with shank portion 22, a connection surface 34 continuous to joint portion 32, and an outer circumferential surface 36 continuous to each of tip end surface 33 and connection surface 34. When viewed in a direction perpendicular to axial line A, a part of outer circumferential surface 36 is exposed through second hole 42 and a remainder of outer circumferential surface 36 is covered with body 10.

According to cutting tool 100 according to (1), when viewed in the direction perpendicular to axial line A, a pan of outer circumferential surface 36 is exposed through second hole 42 and a remainder of outer circumferential surface 36 is covered with body 10. Thus, rigidity of body 10 can be higher than in an example in which a groove is provided in body 10 to expose the entire position adjustment screw 30. Consequently, cutting tool 100 high in rigidity can be provided.

(2) According to cutting tool 100 according to (1), outer circumferential surface 36 may be provided with slits 35 extending along the direction in parallel to axial line A. When viewed in the direction perpendicular to axial line A, a part of slits 35 may be exposed through second hole 42 and a remainder of slits 35 may be covered with body 10. Position adjustment screw 30 can thus be rotated by using slits 35.

(3) According to cutting tool 100 according to (2), in the direction in parallel to axial line A, a length of each of slits 35 may be longer than a width of second hole 42 Thus, even when position adjustment screw 30 is axially moved, slit 35 remains exposed through second hole 42. Therefore, an amount of movement of position adjustment screw 30 can be large. Thus, even when cutting edge portion 21 of blade 20 is worn as a result of use of cutting tool 100 and cutting edge portion 21 is thereafter sharpened again which results in shorter length of blade 20 in the direction in parallel to axial line A, blade 20 can repeatedly be used. Therefore, service life of the same blade 20 can be longer. Furthermore, by not increasing the width of second hole 42 more than necessary, high rigidity of body 10 can be maintained

(4) According to cutting tool 100 according to (2) or (3), a length of each of slits 35 in the direction in parallel to axial line A may be at least two times as long as a diameter of head portion 31.

(5) According to cutting tool 100 according to any one of (2) to (4), in a cross-section perpendicular to axial line A, a circumferential angle between two adjacent slits 35 of slits 35 may be at least one time and at most two times as large as a circumferential angle of second hole 42 in an outer circumferential end surface of body 10. By setting the circumferential angle between two adjacent slits 35 of slits 35 to at least one time as large as the circumferential angle of second hole 42 in the outer circumferential end surface of body 10, the circumferential angle of second hole 42 is not larger than necessary. Consequently, high rigidity of body 10 can be maintained. By pushing slit 35 through second hole 42, position adjustment screw 30 can be rotated By setting the circumferential angle between two adjacent slits 35 of slits 35 to at most two times as large as the circumferential angle of second hole 42. is the outer circumferential end surface of body 10, at least one slit 35 is exposed through second hole 42.

(6) According to cutting tool 100 according to any one of (2) to (5), when viewed in the direction perpendicular to axial line A, at least two slits 35 of slits 35 may be exposed through second hole 42. Slit 35 can thus readily be pushed through second hole 42

(7) According to cutting tool 100 according to any one of (1) 10 (6), tip end surface 33 may be provided with a groove. A tool such as a hex wrench can thus be inserted in first hole 41 and the tool can be turned as being fitted to the groove provided in tip end surface 33. Therefore, the position of position adjustment screw 30 can roughly he adjusted while the tool such as the hex wrench is inserted in first hole 41.

(8) According to cutting tool 100 according to (7), when viewed in the direction in parallel to axial line A, the groove may be hexagonal. The position of position adjustment screw 30 can thus be adjusted by using a hex wrench.

(9) According to cutting tool 100 according to (7). when viewed in the direction in parallel to axial line A, die groove may be linear. The position of position adjustment screw 30 can thus be adjusted by using a fiat blade screwdriver

(10) According to cutting tool 100 according to (1), outer circumferential surface 36 may include a prismatic surface portion 38. When viewed in the direction perpendicular to axial line A, a part of prismatic surface portion 38 may be exposed through second hole 42 and a remainder of prismatic surface portion 38 may be covered with body 10. Position adjustment screw 30 can thus be rotated by using prismatic surface portion 38.

(11) According to cutting tool 100 according to (10), in the direction in parallel to axial line A, a length of prismatic surface portion 38 may be longer than a width of second hole 42. Thus, even when position adjustment screw 30 is axially moved, prismatic surface portion 38 remains exposed through second hole 42. Therefore, an amount of movement of position adjustment screw 30 can be large. Thus, even when cutting edge portion 21 of blade 20 is worn as a result of use of cutting tool 100 and cutting edge portion 21 is thereafter sharpened again which results in shorter length of blade 20 in the direction in parallel to axial line A, blade 20 can repeatedly be used. Therefore, service life of the same blade 20 can be longer. Furthermore, by not increasing the width of second hole 42 more than necessary, high rigidity of body 10 can be maintained.

(12) According to cutting tool 100 according to (10) or (11), a length of prismatic surface portion 38 in the direction in parallel to axial line A may be at least two times as long as a diameter of head portion 31

(13) A cutting tool 100 according to the present disclosure is cutting tool 100 that rotates around an axial line A, and includes a body 10, a blade 20, and a position adjustment screw 30. Body 10 surrounds axial line A. Blade 20 includes a cutting edge portion 21 and a shank portion 22 that holds cutting edge portion 21. Position adjustment screw 30 is in contact with shank portion 22. Body 10 is provided with a first hole 4 1 in which each of shank portion 22 and position adjustment screw 30 is arranged and a second hole 42, first hole 41 extending along a direction in parallel to axial line A, second hole 42 being continuous to first hole 41 and extending along a direction intersecting with axial line A Position adjustment screw 30 includes a head portion 31 in contact with shank portion 22 and a joint portion 32 continuous to head portion 31 and joined to body 10. Head portion 31 includes a tip end surface 33 in contact with shank portion 22, a connection surface 34 continuous to joint portion 32, and an outer circumferential surface 36 continuous to each of tip end surface 33 and connection surface 34. When viewed in a direction perpendicular to axial line A, a pan of outer circumferential surface 36 is exposed through second hole 42 and a remainder of outer circumferential surface 36 is covered with body 10. Outer circumferential surface 36 is provided with slits 35 extending along the direction in parallel to axial line A. When viewed in the direction perpendicular to axial line A, a part of slits 35 is exposed through second hole 42 and a remainder of slits 35 is covered with body 10. In the direction in parallel to axial line A. a length of each of slits 35 is longer than a width of second hole 42. The length of each of slits 35 in the direction in parallel to axial line A is at least two times as long as a diameter of head portion 31. In a cross-section perpendicular to axial line A, a circumferential angle between two adjacent slits 35 of slits 35 is at least one time and at most two times as large as a circumferential angle of second hole 42 in an outer circumferential end surface of body 10. When viewed in the direction perpendicular to axial line A, at least two slits 35 of slits 35 are exposed through second hole 42. Tip end surface 33 is provided with a groove.

According to cutting tool 100 according to (13), head portion 31 of position adjustment screw 30 is provided with slits 35 extending along the direction in parallel to axial line. A When viewed in the direction perpendicular to axial line A, a part of slits 35 is exposed through second hole 42 and a remainder of slits 35 is covered with body 10 Thus, rigidity of body 10 can be higher than in an example in which a groove is provided in body 10 to expose the entire position adjustment screw 30 Consequently., cutting tool 100 high in rigidity can be provided

According to cutting tool 100 according to (13), in the direction in parallel to axial line A, a length of each of slits 35 may be longer than a width of second hole 42. Thus, even when position adjustment screw 30 is axially moved, slit 35 remains exposed through second hole 42 Therefore, an amount of movement of position adjustment screw 30 can be large. Furthermore, by not increasing the width a second hole 42 more than necessary, high rigidity of body 10 can be maintained.

According to cutting tool 100 according to (13), in a cross-section perpendicular to axial line A, a circumferential angle between two adjacent slits 35 of slits 35 may be at least one time and at most two times as large as a circumferential angle of second hole 42 in an outer circumferential end surface of body 10 By setting the circumferential angle between two adjacent slits 35 of slits 35 to at least one time as large the circumferential angle of second hole 42 in the outer circumferential end surface of body 10, the circumferential angle of second hole 42 is not larger than necessary. Consequently. high rigidity of body 10 can be maintained By pushing slit 35 through second bole 42, position adjustment screw 30 can be rotated By setting the circumferential angle between two adjacent slits 35 of slits 35 to at most two times as large as the circumferential angle of second hole 42 in the outer circumferential end surface of body 10, at least one slit 35 is exposed through second hole 42.

According to cutting tool 100 according to (13), when viewed in the direction perpendicular to axial line A, at least two slits 35 of slits 35 may be exposed through second hole 42 Slit 35 can thus readily be pushed through second hole 42.

According to cutting tool 100 according to (13), tip end surface 33 may be provided with a groove A tool such as a hex wrench can thus be inserted in first hole 41 and the tool can be turned as being fitted to the groove provided in tip end surface 33. Therefore, the position of position: adjustment screw 30 can roughly be adjusted while the tool such as the hex wrench is inserted in first hole 41.

Details Embodiment of the Present Disclosure

Details of an embodiment of the present disclosure will now be described with reference to the drawings. The same or corresponding elements in the drawings below have the same reference characters allotted and description thereof will not be repeated.

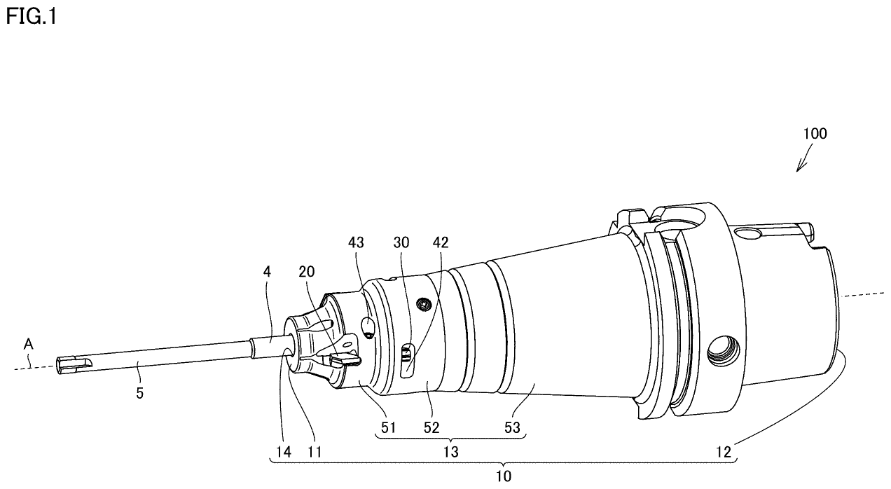

A construction of cutting tool 100 according to the present embodiment will initially be described. FIG. 1 is a schematic perspective view showing the construction of cutting tool 100 according to the present embodiment As Shown in FIG. 1, cutting tool 100 according to the present embodiment is cutting tool 100 that rotates around axial line A, and mainly includes body 10, blade 20, position adjustment screw 30, a reamer, and a support member 4. Cutting tool 100 is, for example, a valve seat machining cutting tool. More specifically, cutting tool 100 is, for example, a valve finisher.

Body 10 surrounds axial line A. Body 10 is cylindrical. Body 10 includes a front end surface 11, a rear end surface 12, an outer circumferential end surface 13, and an inner circumferential end surface 14 in the direction in parallel to axial line A, rear end surface 12 is located opposite to front end surface 11. Rear end surface 12 is a portion attached to a main spindle that drives cutting tool 100. Front end surface 11 is a portion opposed to a work material.

Outer circumferential end surface 13 is continuous to each of front end surface. 11 and rear end surface 12. Outer circumferential end surface 13 surrounds axial line A. Similarly, inner circumferential end surface 14 is continuous to each of font end surface 11 and rear end surface 12. Inner circumferential end surface 14 surrounds axial line A. inner circumferential end surface 14 is located on an inner side of outer circumferential end surface 13. Inner circumferential end surface 14 is surrounded outer circumferential end surface 13.

Reamer 5 is attached to support member 4. Reamer 5 is located at a tip end of cutting tool 100. Support member 4 supports reamer 5. A part of support member 4 is located in the inside of body 10. A part of support member 4 is surrounded by inner circumferential end surface 14 of body 10. Support member 4 extends along axial line A.

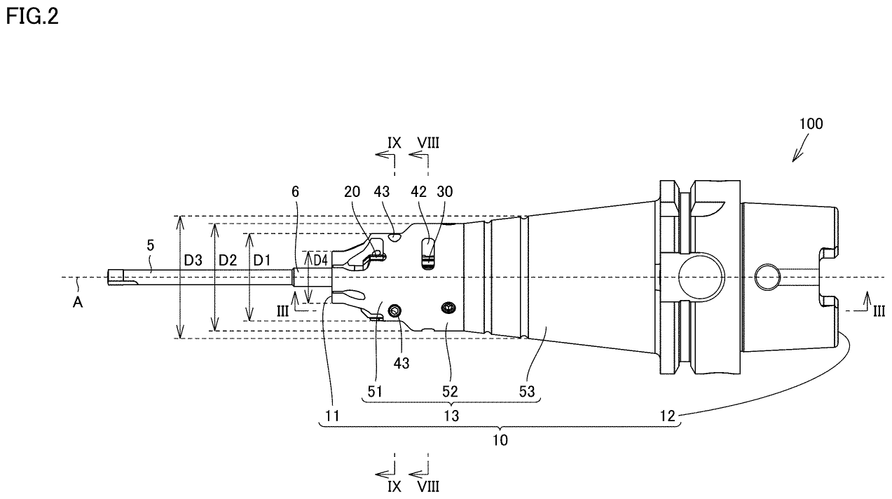

FIG. 2 is a schematic plan view showing the construction of cutting tool 100 according ic the present embodiment. As shown in FIG. 2. outer circumferential end surface 13 includes a first outer circumferential portion 51, a second outer circumferential portion 52, and a third outer circumferential portion 53. In the direction along axial line A, first outer circumferential portion 51 is located between front end surface 11 and second outer circumferential portion 52. In the direction along axial line A, second outer circumferential portion 52 is located between first outer circumferential portion 51 and third outer circumferential portion 53. in the direction along axial line A, third outer circumferential portion 53 is located between second outer circumferential portion 52 and rear end surface 12.

As shown in FIG. 2, a diameter (a first diameter D1) of first outer circumferential portion 51 is larger than a diameter (a fourth diameter D4) of front end surface 11. A diameter (a second diameter D2) of second outer circumferential portion 52 is larger than the diameter (first diameter D1) of first outer circumferential portion 51. Third outer circumferential portion 53 has a diameter increasing from a side of front end surface 11 toward rear end surface 12. A minimum value (a third diameter D3) of the diameter of third outer circumferential portion 53 is larger than the diameter (second diameter D2) of second outer circumferential portion 52. Body 10 is provided with second hole 42 and a third hole 43. Second hole 42 is located in second outer circumferential portion 52. Third hole 43 is located in first outer circumferential portion 51

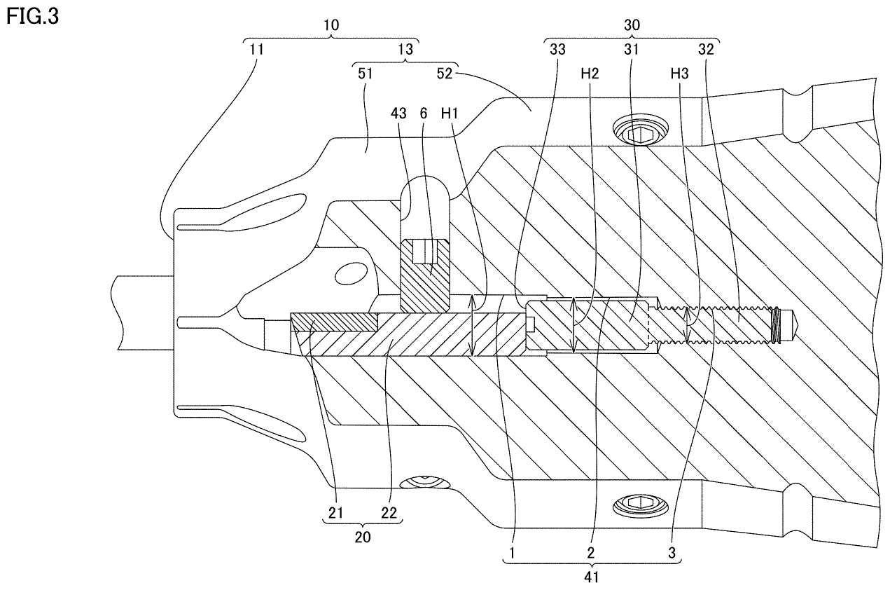

FIG. 3 is a schematic cross-sectional view along the fine III-III in FIG. 2. The cross-section shown in FIG. 3 is a plane in parallel to axial fine A and in parallel to a direction of extension of third hole 43. As shown in FIG. 3, body 10 is provided with first hole 41. First bole 41 extends along the direction in parllel to axial line A First hole 41 opens cm the side of the front end surface. Blade 20 includes cutting edge portion 21 and shank portion 22, Shank portion 22 holds cutting edge portion 21. Shank portion 22 is arranged in first hole 41. At least a part of cutting edge portion 21 is located outside first hole 41.

As shown in FIG. 3, first hole 41 includes a first region 1, a second region 2, and a third region 3. In the direction in parallel to axial line A, first region 1 is located between front end surface 11 and second region 2. In the direction in parallel to axial line A, second region 2 is located between first region 1 and third region 3. Second region 2 is continuous to each of first region 1 and third region 3. In the direction in parallel to axial line A, third region 3 is located between rear end surface 12 and second region 2. First region 1 opens on the side of the front end surface. An inner diameter (a first inner diameter H1) of first region 1 is larger than an inner diameter (a second inner diameter H2) of second region 2. The inner diameter (second inner diameter H2) of second region 2 is larger than an inner diameter (a third inner diameter H3) of third region 3.

Position adjustment screw 30 serves to adjust the position of blade 20 in the direction in parallel to axial line A. Position adjustment screw 30 is arranged in first hole 41. Position adjustment screw 30 is in contact with shank portion 22. Position adjustment screw 30 includes head portion 31 and joint portion 32. Head portion 31 is contact with shank portion 22. Joint portion 32 is continuous to head portion 31. Joint portion 32 is joined to body 10. Head portion 31 is distant from body 10.

Joint portion 32 is joined to body 10. Specifically, joint portion 32 is fastened to third region 3. Joint portion 32 is, for example, a male thread In this case, third region 3 is a female thread to be coupled to the male thread. Joint portion 32 may be, for example, a female thread. In this case, third region 3 is provided with a male thread to be coupled to the female thread.

As shown in FIG. 3, third hole 43 is continuous to first hole 41. The direction of extension of third hole 43 is perpendicular to the direction of extension of first hole 41. Cutting tool 100 includes a fixing screw 6. Fixing screw 6 is arranged in third hole 43. Fixing screw 6 is in contact with shank portion 22. A part of fixing screw 6 protrudes from third hole 43 and is located in first hole 41. By fastening fixing screw 6 to body 10. fixing screw 6 presses shank portion 22 against body 10. Shank portion 22 is thus fixed to body 10.

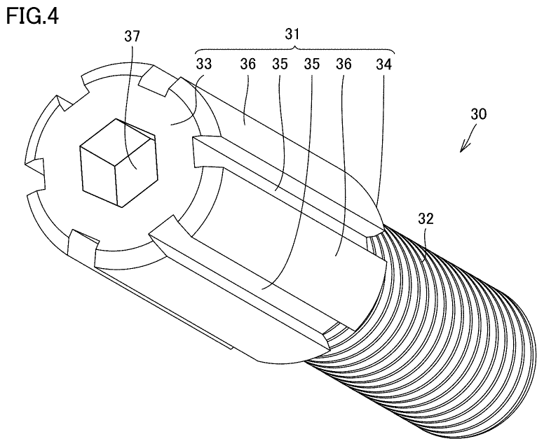

FIG. 4 is a schematic perspective view showing a construction of position adjustment screw 30 of cutting tool 100 according to the present embodiment. As shown in FIG. 4, head portion 31 includes tip end surface 33, connection surface 34, and outer circumferential surface 36. Tip end surface 33 is in contact with shank portion 22. Connection surface 34 is continuous to joint portion 32. Connection surface 34 is located opposite to tip end surface 33. Outer circumferential surface 36 is continuous to each of tip end surface 33 and connection surface 34. Outer circumferential surface 36 is provided with slits 35. For example, six slits 35 are provided, although the number thereof is not particularly limited. Slits 35 may be provided at regular intervals in a circumferential direction of head portion 31. Outer circumferential surface 36 is, for example, curved. Outer circumferential surface 36 may be arc. Outer circumferential surface 36 may be a part of a side surface of a column. A groove 37 may be provided in tip end surface 33.

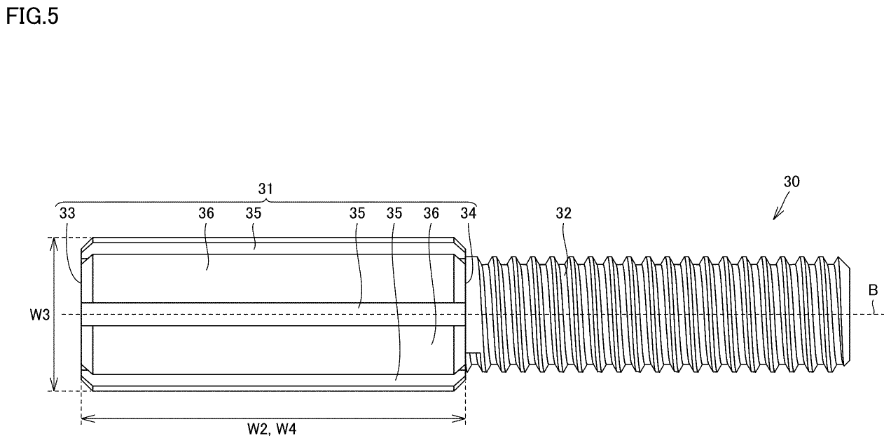

FIG. 5 is a schematic plan view showing the construction of position adjustment screw 30 of cutting tool 100 according to the present embodiment. As shown in FIG. 5, position adjustment screw 30 is in an elongated shape. Each of slits 35 extends along a direction in parallel to a central axis B of position adjustment screw 30. Each of slits 35 may reach tip end surface 33. Each of slits 35 may reach connection surface 34.

When position adjustment screw 30 is arranged in first hole 41, central axis B of position adjustment screw 30 is in parallel to axial line A of cutting tool 109. While position adjustment screw 30 is arranged in first hole 41. each of slits 35 extends along the direction in parallel to axial line A A length (a second width W2) of each of slits 35 in the direction in parallel to axial line A may be ai least two times as long as a diameter (a third width W3) of outer circumferential surface 36. A lower limit of second width W2 may be, for example, at least 2,2 times as large as third width W3, although it is not particularly limited. An upper limit of second width W2 may be, for example, at most four or at most three times as large as third width W3, although it is not particularly limited. in tire direction in parallel to axial line A, the length (second width W2) of each of slits 35 may be the same as a length (a fourth width W4) of head portion 31.

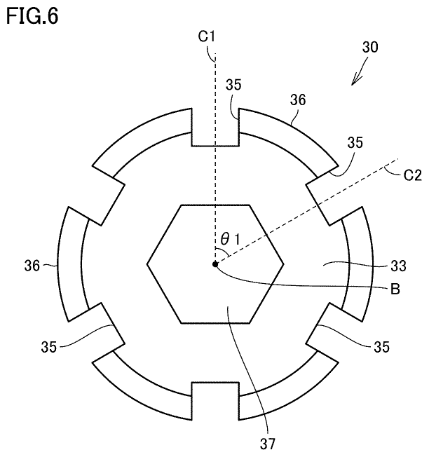

FIG. 6 is a schematic front view showing the construction of position adjustment screw 30 of cutting tool 100 according to the present embodiment. As shown in FIG. 6, when viewed in the direction in parallel to axial line A, groove 37 may be hexagonal. Groove 37 is in a shape, for example, of a regular hexagon. When viewed in the direction in parallel to axial line A, the center of the regular hexagon coincides with central axis B. A depth of groove 37 is smaller than second width W2, although it is not particularly limited.

As shown in FIG. 6, a straight line that divides a bottom surface of first slit 35 perpendicularly into two parts and passes through central axis B is defined as a first straight line C1. Similarly, a straight line that divides a bottom surface of second slit 35 adjacent to first slit 35 perpendicularly into two parts and passes through central axis B is defined as a second straight line C2. In this case, when viewed in the direction in parallel to axial line A, an angle formed between first straight line C1 and second straight line C2 is defined as a first angle θ1. A circumferential angle between two adjacent slits 35 of slits 35 is first angle θ1. First angle θ1 is set, for example, to 60°.

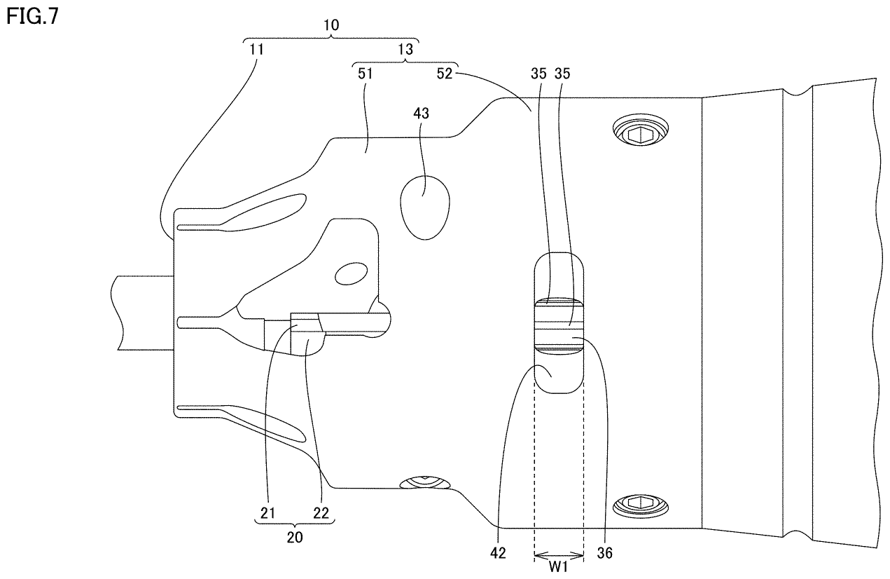

FIG. 7 is a schematic side view showing the construction of cutting tool 100 according to the present embodiment A direction in which FIG. 7 is viewed is perpendicular to axial line A and in parallel to a direction of passage through the center of the inner diameter (second inner diameter H2) of second region 2. The direction in which FIG. 7 is viewed is the same as a direction in which FIG. 3 is viewed. As shown in FIG. 7, when viewed in the direction perpendicular to axial line A, a part of outer circumferential surface 36 is exposed through second hole 42 and a remainder of outer circumferential surface 36 is covered with body 10 From another point of view, a part of outer circumferential surface 36 of position adjustment screw 30 is visually recognizable from the outside of body 10 through second hole 42. When viewed in the direction perpendicular to axial line A, joint portion 32 of position adjustment screw 30 is covered with body 10.

As shown in FIG. 7, when viewed in the direction perpendicular to axial line A, a part of slits 35 is exposed through second hole 42 and a remainder of slits 35 is covered with body 10. From another point of view, a part of slits 35 provided in position adjustment screw 30 is visually recognizable from the outside of body 10 through second hole 42,

When viewed in the direction perpendicular to axial line A, at least two slits 35 slits 35 may be exposed through second hole 42 The lower limit of the number of slits 35 exposed through second hole 42 may be, for example, not smaller than three or not smaller than four, although it is not particularly limited. The upper limit of the number of slits 35 exposed through second hole 42 may be, for example, not larger than ten or not larger than eight, although it is not particularly limited.

As shown in FIG. 7, second hole 42 is provided in second outer circumferential portion 52. In the direction in parallel to axial line A, a width of second hole 42 is defined as first width W1. In the direction in parallel to axial line A, the length (second width W2) of each of slits 35 may be longer than the width (first width W1) of second hole 42. The lower limit of second width W2 may be at least 1.5 time or at least two times as large as first width W1, although it is not particularly limited. The upper limit of second width W2 may be at most ten times or at most five times as large as first width W1, although it is not particularly limited. in the direction in parallel to axial line A, the length (fourth width W4) of head ovation 31 may be longer than the width (first width W1) of second hole 42

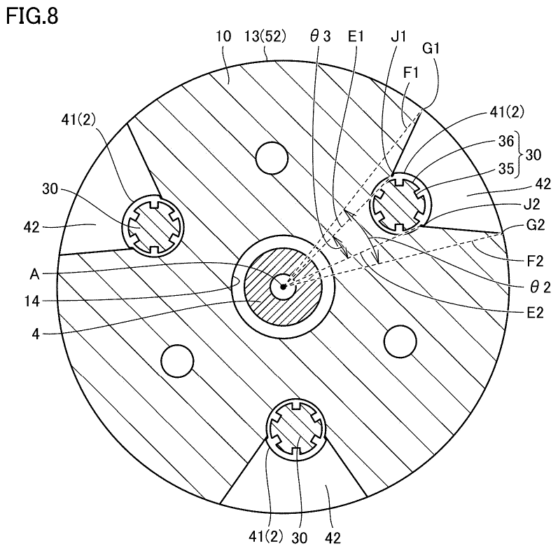

FIG. 5 is a schematic cross-sectional view along the line in FIG. 2. The cross-section shown in FIG. 8 is perpendicular to axial line A and in parallel to the direction of passage through the center of the inner diameter (second inner diameter H2) of second region 2 of first hole 41. As shown in FIG. 8, when viewed in the direction in parallel to axial line A, second hole 42 extends along a direction intersecting with axial line A. Second hole 42 is continuous io first hole 41. The direction of extension of second hole 42 is perpendicular to the direction of extension of first hole 41. When viewed in the direction in parallel to axial line A, a straight line that passes through one end G1 of second hole 42 in outer circumferential end surface 13 and axial line A is defined as a third straight line F1. Similarly, when viewed in the direction in parallel to axial line A, a straight line that passes through the other end G2 of second hole 42 in outer circumferential end surface 13 and axial line A is defined as a fourth straight fine F2. An angle formed between third straight line F1 and fourth straight line F2 is defined as a second angle θ2. A circumferential angle of second hole 42 in outer circumferential end surface 13 of body 10 is second angle θ2. An angle formed by one end G1, axial line A, and the other end G2 is second angle θ2.

As shown in FIG. 8. in the cross-section perpendicular to axial line A, the circumferential angle (first angle θ1) between two adjacent slits 35 of slits 35 (see FIG. 6) may be equal to or larger than the circumferential angle (second angle θ2) of second hole 42 in outer circumferential end surface 13 of body 10. Specifically, first angle θ1 may be at least onetime and at most two times as large as second angle θ2. The lower limit of first angle θ1 may be, for example, at least 1.1 time or at least 1.2 time as large as second angle θ2, although it is not particularly limited. The upper limit of first angle θ1 may be, for example, at most 1.9 time or at most 1.8 time as large as second angle θ2, although it is not. particularly limited

As shown in FIG. 8, in the cross-section perpendicular to axial line A, when viewed in the direction in parallel to axial tine A, a straight line that passes through axial line A and one end J1 of an intersection between first hole 41 and second hole 42 in first hole 41 is defined as a fifth straight line E1. Similarly, when viewed in the direction in parallel to axial line A, a straight line that passes through axial line A and the other end J2 of the intersection between fir st hole 41 and second hole 42 in first hole 41 is defined as a sixth straight line E2 An angle formed between fifth straight line E1 and sixth straight line E2 is defined as a third angle θ3. An angle formed by one end J1, axial line A. and the other end J2 is third angle θ3. Third angle θ3 may be smaller than second angle θ2.

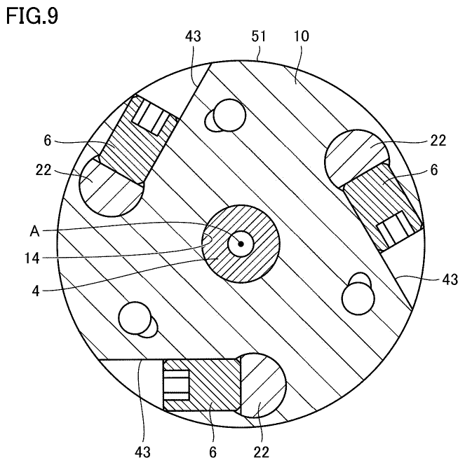

FIG. 9 is a schematic cross-sectional view along the line IX-IX in FIG. 2. The cross-section shown in FIG. 9 is perpendicular to axial line A and in parallel to a direction of extension of third hole 43. As shown in FIG. 9, when viewed in the direction in parallel to axial line A, the direction of extension of third hole 43 does not intersect with axial line A. From another point of view, the straight line along the direction of extension of third hole 43 intersects with a straight tine along the radial direction of body 10. In other words, the straight line along the direction of extension of third hole 43 intersects with the straight line perpendicular to axial line A.

(First Modification)

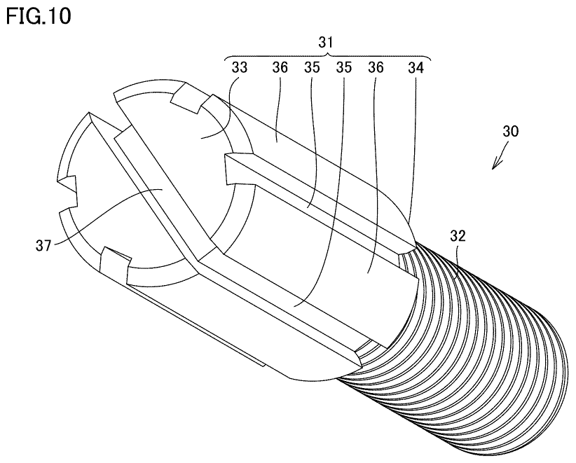

A construction of a first modification of position adjustment screw 30 will now be described. FIG. 10 is a schematic perspective view showing the construction of the first modification of position adjustment screw 30 of cutting tool 100 according to the present embodiment. As shown in FIG. 10, groove 37 is provided in tip end surface 33 of position adjustment screw 30 Groove 37 may be connected to slit 35.

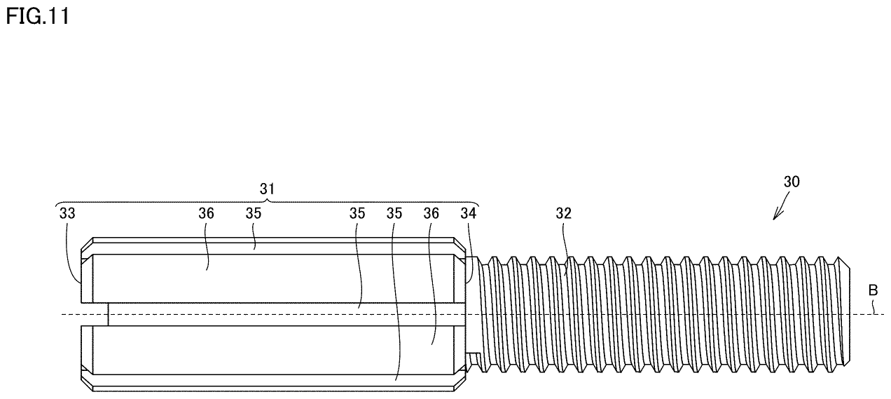

FIG. 11 is a schematic plan view showing the construction of the first modification of position adjustment screw 30 of cutting tool 100 according to the present embodiment. As shown in FIG. 11, each of slits 35 extends along the direction in parallel to central axis B of position adjustment screw 30. A straight line along a longitudinal direction of groove 37 may be perpendicular to a straight line along a longitudinal direction of each of slits 35.

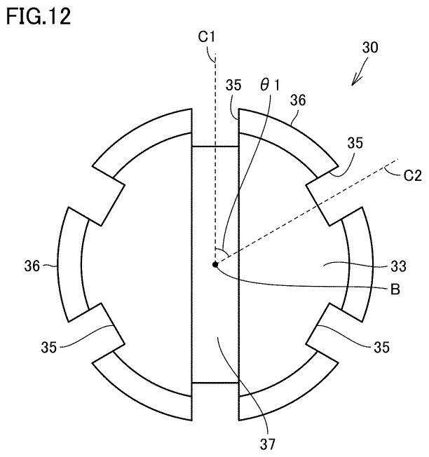

FIG. 12 is a schematic front view showing the construction of the first modification of position adjustment screw 30 of cutting tool 100 according to the present embodiment. As shown in FIG. 12, when viewed in the direction in parallel to axial fine A, groove 37 may be linear. Groove 37 may be, for example, rectangular. When position adjustment screw 30 is arranged in first hole 41, central axis B of position adjustment screw 30 is in parallel to axial line A of cutting tool 100. While position adjustment screw 30 is arranged in first hole 41, each of slits 35 extends along the direction in parallel to axial line A.

As shown FIG. 12, when viewed in the direction in parallel to central axis B, slits 35 are arranged at regular intervals. For example, six slits 35 are provided Groove 37 is connected to two opposing slits 35 of six slits 35, whereas it is distant from four remaining slits 35. In another embodiment, groove 37 may be connected to four slits 35 or six slits 35.

(Second Modification)

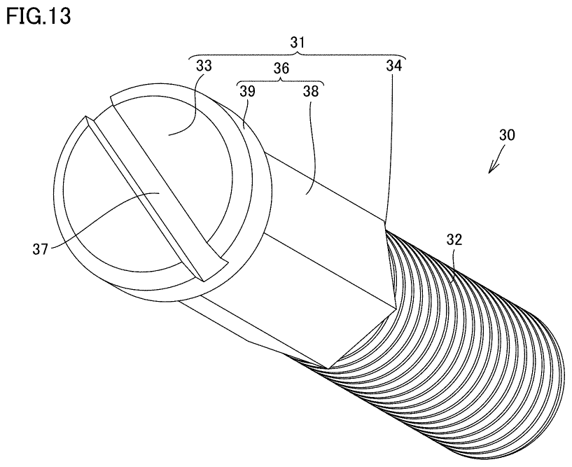

A construction of a second modification of position adjustment screw 30 will now be described. FIG. 13 is a schematic perspective view showing the construction of the second modification of position adjustment screw 30 of cutting tool 100 according to the present embodiment. As shown in FIG. 13, head portion 31 does not have to be provided with slit 35. Outer circumferential surface 36 includes prismatic surface portion 38. Outer circumferential surface 36 may include prismatic surface portion 38 and a curved surface portion 39. Prismatic surface portion 38 is polygonal when viewed in the cross-section perpendicular to central axis B. The polygon is, for example, a hexagon. Curved surface portion 39 may be, for example, a cylindrical surface or a conical surface, or it may include a cylindrical surface and a conical off surface.

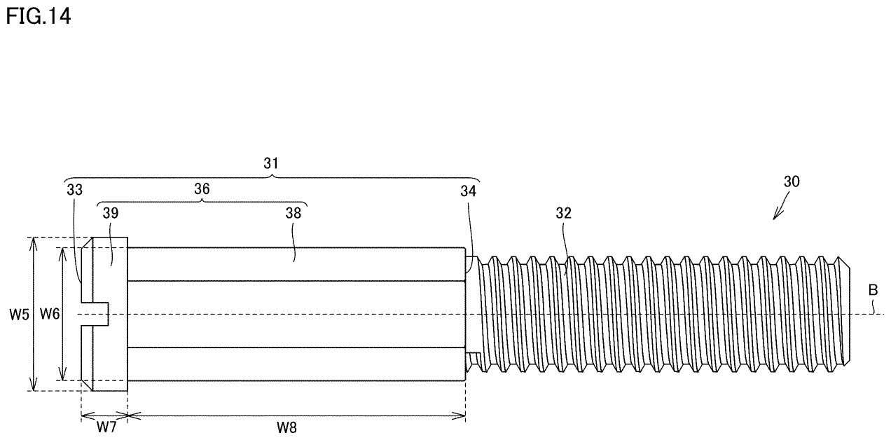

FIG. 14 is a schematic plan view showing the construction of the second modification of position adjustment screw 30 of cutting tool 100 according to the present embodiment. As shown in FIG. 14 prismatic surface portion 38 extends along the direction in parallel to central axis B of position adjustment screw 30. Prismatic surface portion 38 is continuous to connection surface 34. Curved surface portion 39 may be continuous to tip end surface 33. in the direction in parallel to central axis B, curved surface portion 39 may be located between tip end surface 33 and prismatic surface portion 38. Prismatic surface portion 38 may be continuous to tip end surface 33 without curved surface portion 39 being interposed

As shown in FIG. 14, in the direction perpendicular to central axis B, a width (a fifth width W5) of curved sur ace portion 39 may be larger than a width (a sixth width W6) of prismatic surface portion 38. In the direction perpendicular to central axis B, the width (fifth width W5) of curved surface portion 39 may be equal to the width (sixth width W6 of prismatic surface portion 38 The diameter of head portion 31 may be equal to the width (fifth width W5) of curved surface portion 39. As shown in FIG. 14, in the direction in parallel to central axis B, a width (a seventh width W7) of curved surface portion 39 may be smaller than a length (an eighth width W8) of prismatic surface portion 38. In the direction in parallel to central axis B, the length (eighth width 8) of prismatic surface portion 38 may be at least two times as long as the width (fifth width W5) of curved surface portion 39.

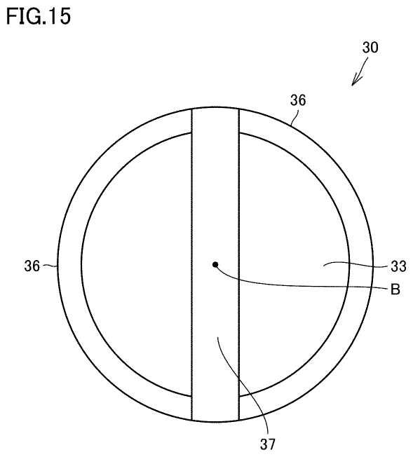

FIG. 15 is a schematic front view showing the construction of the second modification of position adjustment screw 30 of cutting tool 100 according to the present embodiment. As shown in FIG. 15, when viewed in the direction in parallel to axial line A, groove 37 may be linear. When viewed in the direction in parallel to axial line A, groove 37 may be hexagonal. As shown in FIG. 15, groove 37 may be, for example, rectangular. Groove 37 may be in a shape, for example, of a regular hexagon. When position adjustment screw 30 is arranged in first hole 41, central axis B of position adjustment screw 30 is in parallel to axial line A of cutting tool 100 While position adjustment screw 30 is arranged in first hole 41, prismatic surface portion 38 extends along the direction in parallel to axial line A. When viewed in the direction perpendicular to axial line A, a part of prismatic surface portion 38 is exposed in second hole 42 and a remainder of prismatic surface portion 38 is covered with body 10. In the direction in parallel to axial line A, the length (eighth width W8) of prismatic surface portion 38 may be longer than the width (first width W1) of second hole 42.

(Third Modification)

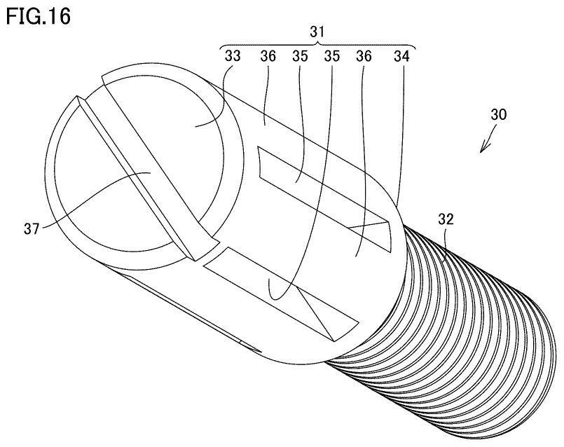

A construction of a third modification of position adjustment screw 30 will now be described. FIG. 6 is a schematic perspective view showing the construction of the third modification of position adjustment screw 30 of cutting tool 100 according, to the present embodiment. As shown in FIG. 16, groove 37 is provided n tip end surface 33 of position adjustment screw 30. Groove 37 may be distant from slit 35.

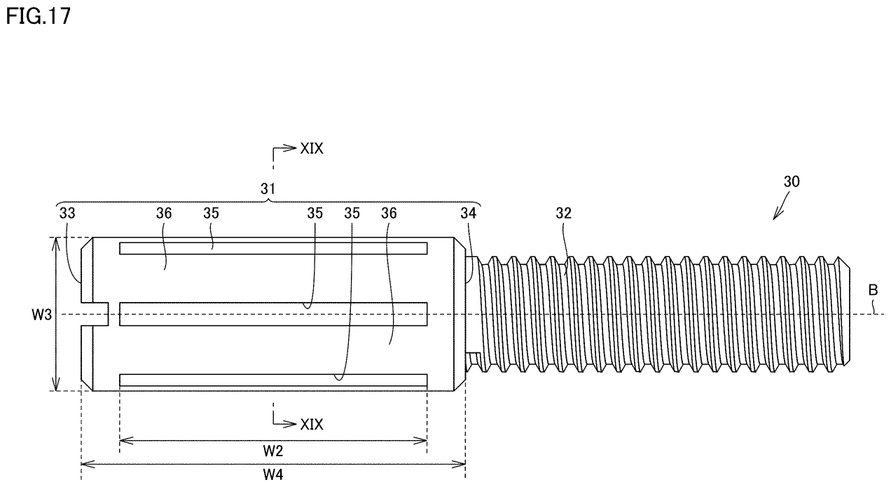

FIG. 17 is a schematic plan view showing the construction of the third modification of position adjustment screw 30 of cutting tool 100 according to the present embodiment. As shown in FIG. 17, each of slits 35 extends along the direction in parallel to central axis B of position adjustment screw 30. Each of slits 35 may be distant from tip end surface 33. Each of slits 35 may be distant from connection surface 34.

When position adjustment screw 30 is arranged first hole 41, central axis B position adjustment screw 30 is in parallel to axial line A of cutting tool 100. While position adjustment screw 30 is arranged in first hole 41, each of slits 35 extends along the direction in parallel to axial line A. In the direction in parallel to axial line A, the length (second width W2) of each of slits 35 may be shorter than the length (fourth width W4) of head portion 31. In the direction in parallel to axial line A, the length (second width W2) of each of slits 35 may be at least half the length (fourth width W4) of head portion 31.

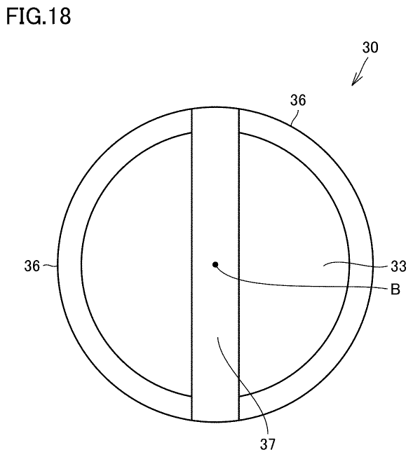

FIG. 18 is a schematic front view showing the construction of the third modification of position adjustment screw 30 of cutting tool 100 according to the present embodiment. As shown in FIG. 18, when viewed in the direction in parallel to axial line A, groove 37 may be linear. Groove 37 may be, for example, rectangular. When position adjustment screw 30 is arranged in first hole 41, central axis B of position adjustment screw 30 is in parallel to axial line A of cutting tool 100. While position adjustment screw 30 is arranged in first hole 41, each of slits 35 extends along the direction in parallel to axial line A.

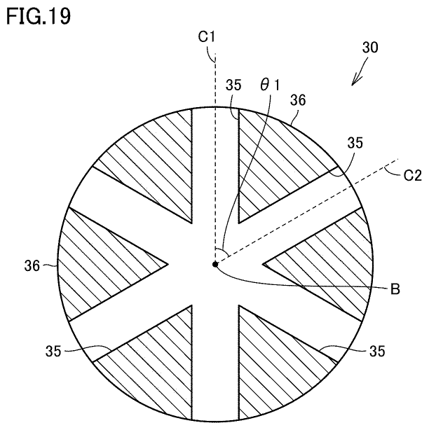

FIG. 19 is a schematic cross-sectional view along the line XIX-XIX in FIG. 17. As shown in FIG. 19, each of slits 35 may be a through hole. Slits 35 may be connected to one another around central axis B. When viewed in the direction along central axis B, each of sins 35 extends radially from central axis B.

A straight line that passes through first slit 35 and passes through central axis B is defined as first straight line Cl. Similarly, a straight line that passes through second slit 35 adjacent to first slit 35 and passes through central axis B is defined as second straight line C2. In this case, when viewed in the direction in parallel to axial line A, an angle formed between first straight line C1 and second straight line C2 is defined as first angle θ1. A circumferential angle between two adjacent slits 35 of slits 35 is first angle θ1. First angle θ1 is set, for example, to 60°.

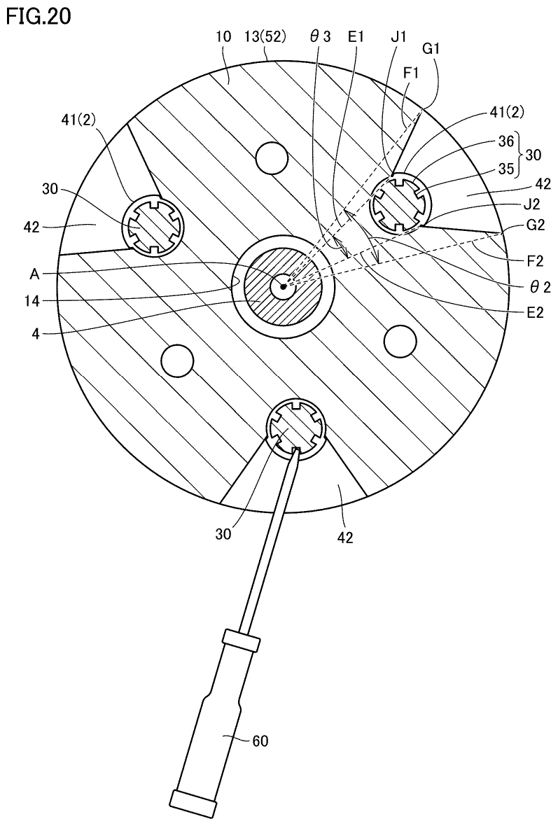

FIG. 20 is a schematic cross-sectional view showing a method of adjusting a position of blade 20 by using position adjustment screw 30. The cross-section in FIG. 20 is the same as the cross-section in FIG. 8. As shown in FIG. 20, a tool such as a flat blade screwdriver 60 is arranged in second hole 42 and brought in contact with slit 35 of position adjustment screw 30. A worker moves flat blade screwdriver 60, for example, back and forth along a direction perpendicular to a straight line in parallel to axial line A. Position adjustment screw 30 thus rotates around central axis B. When position adjustment screw 30 according to the second modification is used, a tool such as a wrench may be used instead of flat blade screwdriver 60.

As shown in FIG. 3, as position adjustment screw 30 rotates around central axis B, position adjustment screw 30 moves along the direction in parallel to axial line A. Blade 20 is in contact with tip end surface 33 of position adjustment screw 30. By varying the position of position adjustment screw 30, the position of blade 20 in the direction in parallel to axial line A can be adjusted.

Functions and effects of cutting tool 100 according to the present embodiment will now be described.

According to cutting tool 100 according to the present embodiment, when viewed in the direction perpendicular to axial line A, a part of outer circumferential surface 36 is exposed through second hole 42 and a remainder or outer circumferential surface 36 is covered with body 10. Thus, rigidity of body 10 can be higher than in an example in which a groove is provided in body 10 to expose the entire position adjustment screw 30. Consequently, cutting tool 100 high in rigidity can be provided.

According to cutting tool 100 according to the present embodiment, outer circumferential surface 36 may be provided with slits 35 extending along the direction in parallel to axial line A. When viewed in the direction perpendicular to axial line A, a part of slits 35 is exposed through second hole 42 and a remainder of slits 35 is covered with body 10. Position adjustment screw 30 can thus be. rotated by using slits 35.

According to cutting tool 100 according to the present embodiment, in the direction in parallel to axial line A, a length of each of slits 35 may be longer than a width of second hole 42. Thus, even when position adjustment screw 30 is axially moved, slit 35 remains exposed through second hole42. Therefore, an amount of movement of position adjustment screw 30 car. he large. Thus, even when cutting edge portion 21 of blade 20 is wont as a result of use of cutting tool 100 and cutting edge portion 21 is thereafter sharpened again which results in shorter length of blade 20 in the direction in parallel to axial line A, blade 20 cat) repeatedly be used Therefore, service life of the same blade 20 can be longer. Furthermore, by not increasing the width of second hole 42 more than necessary, high rigidity of body 10 can be maintained.

According to cutting tool 100 according to the present embodiment, in a cross-section perpendicular to axial line A. a circumferential angle between two adjacent slits 35 of slits 35 may be at least one time and at most two times as large as a circumferential angle of second hole 42 in outer circumferential end surface 13 of body 10. By setting the circumferential angle between two adjacent slits 35 of slits 35 to at least one time as large as the circumferential angle of second hole 42 in outer circumferential end surface 13 of body 10, the circumferential angle of second hole 42 is not larger than necessary. Consequently, high rigidity of body 10 can be maintained By pushing slit 35 through second hole 42, position adjustment screw 30 can be rotated. By setting the circumferential angle between two adjacent slits 35 of slits 35 to at most two times as large as the circumferential angle of second hole 42 in outer circumferential end surface 13 of body 10, at least one slit 35 is exposed through second hole 42.

According to cutting method tool 100 according to the present embodiment, when viewed in the direction perpendicular to line A. at least two slits 35 of slits 35 may be exposed through second hole 42. Slit 35 can thus readily be pushed through second hole 42.

According to cutting tool 100 according to the present embodiment, tip end surface 33 may be provided with groove 37. A tool such as a hex wrench can thus be inserted in first hole 41 and the tool can be turned as being fitted to groove 37 provided in tip end surface 33. Therefore, the position of position adjustment screw 30 can roughly be adjusted while the tool such as the hex wrench is inserted in first hole 41.

According to cutting tool 100 according to the present embodiment, when viewed in the direction in parallel to axial line A, groove 37 may be hexagonal The position of position adjustment screw 30 can thus be adjusted by using a hex wrench.

According to cutting tool 100 according to the present embodiment, when viewed in the direction in parallel to axial line A, groove 37 may be linear. The position of position adjustment screw 30 can thus be adjusted by using at blade screwdriver 60.

According to cutting tool 100 according to the present embodiment, outer circumferential surface 36 may include prismatic surface portion 38. When viewed in the direction perpendicular to axial line A, a part of prismatic surface portion 38 may be exposed through second hole 42 and a remainder of prismatic surface portion 38 may be covered with body 10 Position adjustment screw 30 can thus be rotated by using prismatic surface portion 38.

According to cutting tool 100 according to the present embodiment, in the direction in parallel to axial line A, a length of prismatic surface portion 38 may be longer than a width of second hole 42. Thus, even when position adjustment screw 30 is axially moved, prismatic surface portion 38 remains exposed through second hole 2. Therefore, an amount of movement of position adjustment screw 30 can he large. Thus, when cutting edge portion 21 of blade 20 is worn as a result of use of cutting tool 100 and cutting edge portion 21 is thereafter sharpened again which results in shorter length of blade 20 in the direction in parallel to axial A, blade 20 can repeatedly be used. Therefore, service life of the same blade 20 can be longer. Furthermore, by not increasing the width of second hole 42 more than necessary, high rigidity of body 10 can be maintained.

It should be understood that the embodiment disclosed herein is illustrative and non-restrictive in every respect. The scope the present invention is defined by the terms of the claims rather than the description above and is intended to include any modifications within the scope and meaning equivalent to the terms of the claims.

### REFERENCE SIGNS LIST

1 first region; 2 second region; 3 third region; 4 support member; 5 reamer; 6 fixing screw; 10 body; 11 front end surface; 12 rear end surface; 13 outer circumferential end surface, 14 inner circumferential end surface; 20 blade; 21 cutting edge portion; 22 shank portion, 30 position adjustment screw; 31 head portion, 32 joint portion; 33 tip end surface; 34 connection surface; 35 slit; 36 outer circumferential surface; 37 groove; 38 prismatic surface portion; 39 curved surface portion; 41 first hole; 42 second hole; 43 third hole; 51 first outer circumferential portion; 52 second outer circumferential portion; 53 third outer circumferential portion; 60 flat blade screwdriver; 100 cutting tool; A axial line; B central axis; C1 first straight line; C2 second straight line; D1 first diameter; D2 second diameter; D3 third diameter; D4 fourth diameter; E1 fifth straight line, E2 sixth straight line; F1 third straight line, F2 fourth straight line; G1 one end; G2 the other end; H1 first inner diameter; H2 second inner diameter; H3 third inner diameter; J1 one end; J2 the other end; W1 first width; W2 second width; W3 third width; W4 fourth width; W5 fifth width, W6 sixth width; W7 seventh width; W8 eighth width; θ1 first angle; θ2 second angle; θ3 third angle

1. A cutting tool that rotates around an axial line, the cutting tool comprising:
a body that surrounds the axial line;
a blade including a cutting edge portion and a shank portion that holds the cutting edge portion; and
a position adjustment screw in contact with the shank portion, wherein
the body is provided with a first hole in which each of the shank portion and the position adjustment screw is arranged and a second hole, the first hole extending along a direction in parallel to the axial line, the second hole being continuous to the first hole and extending along a direction intersecting with the axial line,
the position adjustment screw includes a head portion in contact with the shank portion and a joint portion continuous to the head portion and joined to the body,
the head portion includes a tip end surface in contact with the shank portion, a connection surface continuous to the joint portion, and an outer circumferential surface continuous to each of the tip end surface and the connection surface, and
when viewed in a direction perpendicular to the axial line, a part of the outer circumferential surface is exposed through the second hole and a remainder of the outer circumferential surface is covered with the body.

2. The cutting tool according to claim 1, wherein
the outer circumferential surface is provided with slits extending along the direction in parallel to the axial line, and
when viewed in the direction perpendicular to the axial line, a part of the slits is exposed through the second hole and a remainder of the slits is covered with the body.

3. The cutting tool according to claim 2, wherein
in the direction in parallel to the axial line, a length of each of the slits is longer than a width of the second hole.

4. The cutting tool according to claim 2, wherein
a length of each of the slits in the direction in parallel to the axial line is at least two times as long as a diameter of the outer circumferential surface.

5. The cutting tool according to claim 2, wherein
in a cross-section perpendicular to the axial line, a circumferential angle between two adjacent slits of the slits is at least one time and at most two times as large as a circumferential angle of the second hole in an outer circumferential end surface of the body.

6. The cutting tool according to claim 2, wherein
when viewed in the direction perpendicular to the axial line, at least two slits of the slits are exposed through the second hole.

7. The cutting tool according to claim 1, wherein
the tip end surface is provided with a groove.

8. The cutting tool according to claim 7, wherein
when viewed in the direction in parallel to the axial line, the groove is hexagonal.

9. The cutting tool according to claim 7, wherein
when viewed in the direction in parallel to the axial line, the groove is linear.

10. The cutting tool according to claim 1, wherein
the outer circumferential surface includes a prismatic surface portion, and
when viewed in the direction perpendicular to the axial line, a part of the prismatic surface portion is exposed through the second hole and a remainder of the prismatic surface portion is covered with the body.

11. The cutting tool according to claim 10, wherein
in the direction in parallel to the axial line, a length of the prismatic surface portion is longer than a width of the second hole.

12. The cutting tool according to claim 10, wherein
a length of the prismatic surface portion in the direction in parallel to the axial line is at least two times as long as a diameter of the outer circumferential surface.

13. (canceled)

14. The cutting tool according to claim 3, wherein
a length of each of the slits in the direction in parallel to the axial line is at least two times as long as a diameter of the outer circumferential surface.

15. The cutting tool according to claim 3, wherein
in a cross-section perpendicular to the axial line, a circumferential angle between two adjacent slits of the slits is at least one time and at most two times as large as a circumferential angle of the second hole in an outer circumferential end surface of the body.

16. The cutting tool according to claim 4, wherein
in a cross-section perpendicular to the axial line, a circumferential angle between two adjacent slits of the slits is at least one time and at most two times as large as a circumferential angle of the second hole in an outer circumferential end surface of the body.

17. The cutting tool according to claim 3, wherein
in a cross-section perpendicular to the axial line, a circumferential angle between two adjacent slits of the slits is at least one time and at most two times as large as a circumferential angle of the second hole in an outer circumferential end surface of the body.

18. The cutting tool according to claim 4, wherein
in a cross-section perpendicular to the axial line, a circumferential angle between two adjacent slits of the slits is at least one time and at most two times as large as a circumferential angle of the second hole in an outer circumferential end surface of the body.

19. The cutting tool according to claim 3, wherein
when viewed in the direction perpendicular to the axial line, at least two slits of the slits are exposed through the second hole.

20. The cutting tool according to claim 4, wherein
when viewed in the direction perpendicular to the axial line, at least two slits of the slits are exposed through the second hole.

21. A cutting tool that rotates around an axial line, the cutting tool comprising:
a body that surrounds the axial line;
a blade including a cutting edge portion and a shank portion that holds the cutting edge portion; and
a position adjustment screw in contact with the shank portion, wherein
the body is provided with a first hole in which each of the shank portion and the position adjustment screw is arranged and a second hole, the first hole extending along a direction in parallel to the axial line, the second hole being continuous to the first hole and extending along a direction intersecting with the axial line,
the position adjustment screw includes a head portion in contact with the shank portion and a joint portion continuous to the head portion and joined to the body,
the head portion includes a tip end surface in contact with the shank portion, a connection surface continuous to the joint portion, and an outer circumferential surface continuous to each of the tip end surface and the connection surface,
when viewed in a direction perpendicular to the axial line, a part of the outer circumferential surface is exposed through the second hole and a remainder of the outer circumferential surface is covered with the body,
the outer circumferential surface is provided with slits extending along the direction in parallel to the axial line,
when viewed in the direction perpendicular to the axial line, a part of the slits is exposed through the second hole and a remainder of the slits is covered with the body,
in the direction in parallel to the axial line, a length of each of the slits is longer than a width of the second hole,
the length of each of the slits in the direction in parallel to the axial line is at least two times as long as a diameter of the outer circumferential surface,
in a cross-section perpendicular to the axial line, a circumferential angle between two adjacent slits of the slits is at least one time and at most two times as large as a circumferential angle of the second hole in an outer circumferential end surface of the body,
when viewed in the direction perpendicular to the axial line, at least two slits of the slits are exposed through the second hole, and
the tip end surface is provided with a groove.
